(19) United States
(12) Patent Application Publication
(10) Pub. No.: US 2010/0189811 A1
(43) Pub. Date: Jul. 29, 2010

(54) Biocide compositions comprising 3-methylisothiazolin-3-one and a haloalkyl sulphone

(75) Inventors: Rudiger Baum, Waghausel (DE); Hans-Jurgen Schmidt, Speyer (DE); Thomas Wunder, Neustadt (DE); Christos Savides, Fairfield, CT (US)

Correspondence Address: HEDMAN & COSTIGAN, P.C., 1230 AVENUE OF THE AMERICAS, 7th floor, NEW YORK, NY, 10020, US

(73) Assignee: THOR GmbH, Speyer (DE)

(21) Appl. No.: 12/657,863

(22) Filed: Jan. 28, 2010

(30) Foreign Application Priority Data
Jan. 29, 2009 (EP) 09 151 676.5

(51) Int. Cl. A01N 55/02; A01N 43/80; A01N 59/16; A01N 43/90; A01P 1/00; A01P 3/00

(52) U.S. Cl. 424/618; 514/372; 514/186; 514/278

(57) ABSTRACT

The invention relates to a biocide composition comprising, as active microbicidal components, 2-methylisothiazolin-3-one and also one or more haloalkyl sulphones, said composition being outstandingly suitable as an industrial preservative for protecting industrial products. The invention further relates to the use of haloalkyl sulphones as an additive for reducing “emissions” from compositions containing 2-methylisothiazolin-3-one.

The invention relates to a biocide composition which comprises, as active microbicidal components, 2-methylisothiazolin-3-one and one or more haloalkyl sulphones. The invention further relates to the use of specific additives for reducing emissions from compositions containing 2-methylisothiazolin-3-one.

Biocidal products are used in numerous areas, such as for controlling bacteria, fungi and algae, for example. The use of isothiazolin-3-ones (which are also referred to as 3-isothiazolones) in such biocidal products is well established, since this class of compound includes highly active biocidal compounds.

One of the aforementioned effective biocidal compounds is 5-chloro-2-methylisothiazolin-3-one. This compound does have a good biocidal action, but has a variety of disadvantages in its practical handling. For instance, the compound frequently triggers allergies in those persons involved with it. Additionally, in certain countries, there are statutory restrictions on the AOX level; that is, there is a certain concentration of organic chlorine, bromine and iodine compounds that absorb on activated carbon that must not be exceeded in the water. This then largely prevents the use of 5-chloro-2-methylisothiazolin-3-one in the desired extent, or allows the use of 5-chloro-2-methylisothiazolin-3-one only in small amounts. Furthermore, the stability of this compound is inadequate under certain conditions, as for example at high pH levels or in the presence of nucleophiles or reducing agents.

Another known isothiazolin-3-one with biocidal action is 2-methylisothiazolin-3-one. This compound does avoid various disadvantages of the aforementioned 5-chloro-2-methylisothiazolin-3-one, an example being the abovementioned risk of allergy, but has a substantially lower biocidal action as compared with 5-chloro-2-methylisothiazolin-3-one. Simply replacing 5-chloro-2-methylisothiazolin-3-one by 2-methylisothiazolin-3 one is therefore not readily possible without suffering a substantial loss of biocidal action.

Using a combination of different isothiazolin-3-ones is known. Thus, for example, EP-A 0 676 140 discloses a synergistic biocide composition which comprises 2-methylisothiazolin-3-one and 2-n-octylisothiazolin-3-one.

EP-B 1 005 271 discloses further biocide compositions which comprise a synergistic active combination of 2-methylisothiazolin-3-one and 1,2-benzisothiazolin-3-one. These biocide compositions are free from 5-chloro-2-methylisothiazolin-3-one.

Likewise disclosed, by EP-B 1 030 558, is a synergistic biocide composition, comprising 2-methylisothiazolin-3-one and 3-iodo-2-propynyl N-butylcarbamate. This synergistic composition is suitable even at low concentrations for controlling microorganisms.

On the basis of the prior art as discussed above, there is a need for further biocide compositions whose active microbicidal components interact synergistically and therefore when used in combination can be employed at lower concentrations, as compared with the required concentrations in the case of the individual components.

When surfaces are coated with coating materials such as emulsion paints it is possible for unpleasant odours to occur. This phenomenon occurs, for example, when paints or renders are used to coat surfaces in the interior and exterior sector. Unpleasant nuisance odours are perceived as being particularly unpleasant especially in the interior sector, owing to inadequate ventilation.

A hitherto largely unresearched and to date unresolved problem is that referred to as “ghost odour”. It entails a nuisance odour occurring in rooms that have coatings that have already dried and filmed, and in some cases coatings that are already fairly old. Examples of these coatings are films of paint or render on surfaces in the interior sector. This ghost odour may occur days, weeks or months after the coating has been applied, and is described and perceived as being like cat's urine, perspiration, onion, rubber or fruit. It is also known that this ghost odour can be perceived with particular intensity in warm weather and at relatively high temperatures, at relatively high atmospheric humidity, in many cases also after a room has been ventilated, under intense sunlight, and especially in association with exposure to ozone.

The method described in the examples allows standardized detection of the ghost odour. Persons with a normal sense of smell who have been exposed to the ghost odour are able to recognize this odour again beyond doubt.

Investigations show that sulphur compounds are critically involved in the development of odour. Sulphur compounds in coating materials may originate from many different sources. They may be present in the products themselves or in the raw materials used to prepare them, as part of the formula, or may be present as contaminants that are due to production, storage or transport. The sulphur compounds in question may be compounds either of synthetic origin or of biogenic origin. One compound which may give rise to the occurrence of ghost odour in coatings or coating materials is 2-methyl-4-isothiazolin-3-one (MIT).

Avoiding sulphur compounds in coating materials in order to prevent ghost odour is often difficult, since even extremely small amounts may give rise to the odour.

On the basis of the prior art, the object of the invention is to provide a further biocide composition whose active microbicidal components interact synergistically and therefore when used in unison can be employed at lower concentrations as compared with the required concentrations in the case of the individual components.

A further object of the invention is to provide additives or compounds for the extensive prevention of ghost odour in compositions containing 2-methyl-4-isothiazolin-3-one. These compounds are more particularly to be provided as inhibitors for preventing ghost odour, largely preventing the appearance of ghost odour in films, coatings and containers preserved using 2-methyl-4-isothiazolin-3-one.

This object is achieved by the invention by means of a biocide composition comprising as active microbicidal components 2-methylisothiazolin-3-one and one or more haloalkyl sulphones according to the general structural formula I,

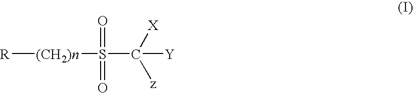

where
R is selected from the group consisting of H, alkyl, cycloalkyl, aralkyl, aryl, alkoxyaryl and heteroaryl, the groups alkyl, cycloalkyl, aralkyl, aryl, alkoxyaryl and heteroaryl being optionally substituted by one or more substituents.

The substituents are selected independently of each other from the group consisting of fluorine, chlorine, bromine, iodine, hydroxyl, unsubstituted or substituted alkyl, unsubstituted or substituted aryl, unsubstituted or substituted heteroaryl, unsubstituted or substituted aralkyl, alkoxy, amino, nitro, carboxyl, carboalkoxy, cyano, alkylamino, hydroxyalkyl, mercaptyl, alkylmercaptyl, trihaloalkyl, carboxyalkyl, carbamoyl, —(C₁-C₂)alkyl, —PF₃, —O—(C₁-C₂)alkyl, —NH—(C₁-C₄)alkyl, —N((C₁-C₄)alkyl)₂, —NH—CHO, —NH—CO—(C₁-C₄)alkyl, —CO—NH₂, —CO—NH—(C₁-C₄)alkyl, —CO—N((C₁-C₄)alkyl)₂ and —CO—OH.

X, Y and Z are selected independently of one another from the group consisting of hydrogen, fluorine, chlorine, bromine and iodine, with at least one of X, Y and Z being a halogen atom. In a further preferred embodiment of the invention X, Y and Z are selected independently of one other from the group consisting of hydrogen, fluorine, chlorine, bromine and iodine, with at least two being a halogen atom. In a particularly preferred embodiment of the invention X, Y and Z are selected independently of one other from the group consisting of hydrogen, fluorine, chlorine, bromine and iodine, and have a total atomic weight of more than 110.

n is an integer from 0 to 4. In one preferred embodiment of the invention n is an integer from 0 to 2, and more preferably n is 0.

“Alkyl” denotes a saturated aliphatic hydrocarbon group, which may be straight-chain or branched and may have from 1 to 20 carbon atoms in the chain. Preferred alkyl groups may be straight-chain or branched and have from 1 up to 10 carbon atoms in the chain. Branched means that a lower alkyl group, such as methyl, ethyl or propyl, is attached to a linear alkyl chain. Alkyl is for example methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl and 1-octadecyl. “Substituted alkyl” means that the alkyl group is substituted by one or more substituents selected from alkyl, unsubstituted or substituted aryl, unsubstituted or substituted aralkyl, alkoxy, amino, nitro, carboxyl, carboalkoxy, cyano, alkylamino, halo, hydroxyl, hydroxyalkyl, mercaptyl, alkylmercaptyl, trihaloalkyl, carboxyalkyl or carbamoyl.

“Cycloalkyl” denotes an aliphatic ring which has from 3 to approximately 10 carbon atoms in a ring. Preferred cycloalkyl groups have from 4 to approximately 7 carbon atoms in the ring.

“Aralkyl” denotes an alkyl group which is substituted by an aryl radical, with “aryl” denoting phenyl or naphthyl. “Substituted aralkyl” and “substituted aryl” mean that the aryl group, or the aryl group of the aralkyl group, is substituted by one or more substituents selected from alkyl, alkoxy, amino, nitro, carboxyl, carboalkoxy, cyano, alkylamino, halo, hydroxyl, hydroxyalkyl, mercaptyl, alkylmercaptyl, trihaloalkyl, carboxyalkyl or carbamoyl.

“Alkoxy” denotes an alkyl-O— group in which “alkyl” has the definition described above. Lower alkoxy groups are preferred. Included as exemplary groups are methoxy, ethoxy, n-propoxy, isopropoxy and n-butoxy.

“Lower alkyl” denotes an alkyl group containing 1 to approximately 7 carbon atoms.

“Alkoxyalkyl” denotes an alkyl group as described above which is substituted by an alkoxy group as described above.

“Halogen” (or “halo”) denotes chlorine (chloro), fluorine (fluoro), bromine (bromo) or iodine (iodo).

“Heterocyclyl” denotes an approximately 4- to approximately 10-membered ring structure in which one or more of the ring atoms is an element other than carbon, such as N, O or S, for example. Heterocyclyl may be aromatic or non-aromatic; i.e. it may be saturated, partially unsaturated or wholly unsaturated.

Preferred heterocyclyl groups included are as follows: pyridyl, pyridazinyl, pyrimidinyl, isoquinolyl, quinolyl, quinazolinyl, imidazolyl, pyrrolyl, furanyl, thienyl, thiazolyl, benzothiazolyl, piperidyl, pyrrolidinyl, tetrahydropyranyl, tetrahydropyranyl and morpholinyl groups.

“Substituted heterocyclyl” means that the heterocyclyl group is substituted by one or more substituents, substituents included being as follows: alkoxy, alkylamino, aryl, carbalkoxy, carbamoyl, cyano, halo, heterocyclyl, trihalomethyl, hydroxyl, mercaptyl, alkylmercaptyl or nitro.

“Hydroxyalkyl” denotes an alkyl group which is substituted by a hydroxyl group. Hydroxy-lower alkyl groups are preferred. Exemplarily preferred groups included are as follows: hydroxymethyl, 2-hydroxyethyl, 2-hydroxypropyl and 3-hydroxypropyl.

“Carboxyl” denotes a COOH group.

“Alkoxycarbonyl” denotes an alkoxy-C═O group.

“Aralkoxycarbonyl” denotes an aralkyl-O—C═O group.

“Aryloxycarbonyl” denotes an aryl-O—C═O group.

“Carbalkoxy” denotes a carboxyl substituent which is esterified with an alcohol of the formula CₙH₂ₙ₊₁OH, n being from 1 to approximately 6.

“Carbamoyl” denotes a

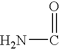

group. Alkylcarbamoyl and dialkylcarbamoyl mean that the nitrogen of the carbamoyl is substituted by one or two alkyl groups respectively.

“Alkoxyalkyl” denotes an alkyl group as described above which is substituted by an alkoxy group as described above.

Compounds of the above-defined general formula I are known and are described for example in U.S. Pat. No. 3,615,745.

The haloalkyl sulphones are, for the purposes of the invention, compounds according to the general formula I. In one preferred embodiment the compound or compounds according to the general formula I are selected from the group consisting of 4-tolyl diiodomethyl sulphone, phenyl diiodomethyl sulphone, 4-tolyl dibromomethyl sulphone, 4-tolyl tribromomethyl sulphone, 4-(methylamido)phenyl diiodomethyl sulphone, n-heptyl diiodomethyl sulphone, 4-aminophenyl diiodomethyl sulphone, 4-chlorophenyl diiodomethyl sulphone, 4-tert-butylphenyl diiodomethyl sulphone, 3-tolyl diiodomethyl sulphone, 2-tolyl-diiodomethyl sulphone, 4-bromophenyl diiodomethyl sulphone, 2-methyl-4-chlorophenyl diiodomethyl sulphone, α-naphthyl diiodomethyl sulphone, 2-methyl 4-bromophenyl diiodomethyl sulphone, 3-methyl-4-bromophenyl diiodomethyl sulphone, n-butyl diiodomethyl sulphone, benzyl diiodomethyl sulphone, 2,4-dimethylphenyl diiodomethyl sulphone, 3,4-dichlorophenyl diiodomethyl sulphone, 4-chlorophenyl dibromomethyl sulphone, 4-methoxyphenyl dibromomethyl sulphone, ethyl diiodomethyl sulphone, tert-butyl diiodomethyl sulphone, 4-chlorophenyl tribromomethyl sulphone, 4-methoxyphenyl tribromomethyl sulphone, benzyl iodomethyl sulphone, ethyl diiodomethyl sulphone, 2-methyl-4-tert-butylphenyl diiodomethyl sulphone, 2-nitro-4-methylphenyl dibromomethyl sulphone, 2-nitro-4-methylphenyl tribromomethyl sulphone, 3-tolyl tribromomethyl sulphone, 4-tert-butylphenyl bromomethyl sulphone, 2-nitro-4-methylphenyl iodomethyl sulphone, 4-chlorobenzyl diiodomethyl sulphone, 2-nitro-4-chlorophenyl iodomethyl sulphone, 2-nitro-4-chlorophenyl tribromomethyl sulphone, 4-nitrophenyl diiodomethyl sulphone, 2-methyl 4-tert-butylphenyl tribromomethyl sulphone, 2-nitro-4-chlorophenyl diiodomethyl sulphone, 2-isopropylphenyl bromomethyl sulphone, 2-isopropylphenyl diiodomethyl sulphone, 4-nitrophenyl tribromomethyl sulphone, 4-(2,2-dimethylpropyl)phenyl diiodomethyl sulphone, 4-chlorobenzyl diiodomethyl sulphone, cyclohexyl diiodomethyl sulphone, n-pentyl diiodomethyl sulphone, n-hexyl diiodomethyl sulphone, n-propyl diiodomethyl sulphone, n-octyl diiodomethyl sulphone, 4-methylbenzyl diiodomethyl sulphone, 4-fluorobenzyl diiodomethyl sulphone, 4-bromobenzyl diiodomethyl sulphone, 4-methoxybenzyl diiodomethyl sulphone, 3-chlorobenzyl diiodomethyl sulphone, 3,5-dimethyl diiodomethyl sulphone, 1-phenyl-2-(diiodomethylsulphonyl)ethane, 3-bromobenzyl diiodomethyl sulphone, 2-naphthylmethyl diiodomethyl sulphone, 1-phenyl-3-(diiodomethylsulphonyl)propane, isobutyl diiodomethyl sulphone, 3,4-dimethylbenzyl diiodomethyl sulphone, 3,3-dimethylpropyl diiodomethyl sulphone, 2,2,4,4-tetramethylbutyl diiodomethyl sulphone, 4-fluorobenzyl dibromomethyl sulphone, 3-chlorobenzyl dibromomethyl sulphone, 4-bromobenzyl dibromomethyl sulphone, 3,4-dichlorobenzyl dibromomethyl sulphone, 2,4-dichlorobenzyl dibromomethyl sulphone, 3-bromobenzyl dibromomethyl sulphone, 2-bromobenzyl dibromomethyl sulphone, 2-chlorobenzyl dibromomethyl sulphone, 4-methylbenzyl dibromomethyl sulphone, 2-methylbenzyl dibromomethyl sulphone, 3-methylbenzyl dibromomethyl sulphone, 4-nitrobenzyl dibromomethyl sulphone, 4-methoxybenzyl dibromomethyl sulphone, 2,5-dimethylbenzyl dibromomethyl sulphone, 3,4-dimethylbenzyl dibromomethyl sulphone, 1-phenyl-2-dibromomethylsulphonyl ethane, 1-phenyl-3-(dibromomethylsulphonyl)propane, cyclohexyl dibromomethyl sulphone, n-heptyl dibromomethyl sulphone, n-decyl dibromomethyl sulphone, n-hexadecyl dibromomethyl sulphone, 3-methylpropyl diiodomethyl sulphone and n-decyl diiodomethyl sulphone.

In one preferred embodiment of the invention X is hydrogen and Y and Z are iodine. In this preferred embodiment of the invention the compound according to the general formula I is diiodomethyl p-tolyl sulphone. Diiodomethyl p-tolyl sulphone, also called DIMTS below, is the compound having the CAS Number 20018-09-1 which is also listed in Chemical Abstracts under the names 4-methylphenyl diiodomethyl sulphone, 1-((diiodomethyl)sulphonyl)-4-methylbenzene; diiodomethyl p-tolyl sulphone and 4-(diiodomethylsulphonyl)toluene. This compound is sold under the brand name AMICAL™ (for example as AMICAL 48) by The Dow Chemical Company and as a biocide has a good fungicidal activity.

The biocide composition of the invention has the advantage that the MIT and the haloalkyl sulphone, especially MIT and the diiodomethyl p-tolyl sulphone, interact synergistically and therefore when used in unison can be employed at low concentrations, compared with low concentrations in the case of the individual components. Moreover, the biocide composition of the invention can if needed be prepared exclusively with water as liquid medium. These biocide compositions are advantageously free from organic solvents.

A further advantage of the biocide composition of the invention is that the haloalkyl sulphone or haloalkyl sulphones are suitable as additives for reducing or even entirely preventing the occurrence of ghost odour in MIT-containing compositions and in MIT-containing products or coating materials and coatings.

The coating materials in this context may be industrial products and materials such as paints, varnishes, glazes and stucco, emulsions, latices and polymer dispersions. The additives are additionally suitable for at least substantial prevention or at least substantial reduction of ghost odour in products such as chalk suspensions, mineral slurries, adhesives, pigment pastes and pigment dispersions, thickeners, liquids and raw materials in paper processing. With preference the compounds of the invention are suitable for preventing ghost odour in coatings which are obtainable by applying the aforementioned coating materials to surfaces (a drying step may be necessary). The compounds are suitable, furthermore, for the prevention of ghost odour in the corresponding containers (in can). Container in the sense of the present specification means a preserved product or coating material such as a paint, a varnish, a glaze, an emulsion, a dispersion of polymers in aqueous media, and a polymer dispersion. The preserved products and coating materials are described in more detail later on in the specification.

In one embodiment of the present invention the biocide composition of the invention comprises the 2-methylisothiazolin-3-one and the haloalkyl sulphone in a weight ratio of (100 to 1):(1 to 50), preferably in a weight ratio of (20 to 1):(1 to 10), more particularly in a weight ratio of (10 to 1):(1 to 2). In a further embodiment of the invention the 2-methylisothiazolin-3-one and the haloalkyl sulphone are present in a ratio to one another in which a synergistic effect can be detected. In this case the 2-methylisothiazolin-3-one is present in the range from 0.6% to 99.8% by weight relative to the haloalkyl sulphone in the range from 0.2% to 99.4% by weight, based on the total mass of the biocides present in the biocide composition.

In a preferred embodiment of the present invention the biocide composition of the invention comprises the 2-methylisothiazolin-3-one and the haloalkyl sulphone, more particularly the diiodomethyl p-tolyl sulphone, in a weight ratio of (100 to 1):(1 to 50), preferably in a weight ratio of (20 to 1):(1 to 10), more particularly in a weight ratio of (10 to 1):(1 to 2). In a preferred embodiment of the invention the 2-methylisothiazolin-3-one and the haloalkyl sulphone, more particularly the diiodomethyl p-tolyl sulphone, are present in a ratio to one another in which a synergistic effect can be detected. In this case the 2-methylisothiazolin-3-one is present in the range from 0.6% to 99.8% by weight relative to the haloalkyl sulphone, in particular the diiodomethyl p-tolyl sulphone, in the range from 0.25% to 99.4% by weight, based on the total mass of the biocides present in the biocide composition.

A mixture comprising exclusively MIT and one or more haloalkyl sulphones in the stated weight ratios in the absence of any further component is referred to below as “biocide mixture of the invention”. A “biocide composition of the invention” may contain one or more further constituents besides MIT and one or more haloalkyl sulphones in the stated weight ratios. The further constituent or constituents may have a microbicidal action, or they may have no microbicidal action, hence being, for instance, a solvent, dispersing agent or suspension agent.

It is advantageous if the biocide composition of the invention comprises MIT and the haloalkyl sulphone, more particularly the diiodomethyl p-tolyl sulphone, in a total concentration of 0.5% to 50%, preferably of 1% to 20%, more preferably of 2.5% to 10%, by weight, based in each case on the total biocide composition.

In a further embodiment the biocide composition of the invention is composed predominantly of MIT/haloalkyl sulphone in the proportions indicated above (i.e. the biocide mixture of the invention). This means that the biocide composition of the invention comprises as its major constituent the biocide mixture of the invention, preferably in an amount of greater than or equal to 50%, more preferably in an amount of greater than or equal to 70%, in particular in an amount of greater than or equal to 90%, and more particularly in an amount of greater than or equal to 95%, by weight, based on the total mass of active biocidal compound. In addition there may be at least one further biocide present, and also one or more solvents, dispersing agents or suspension agents.

In another embodiment of the invention the biocide composition of the invention is composed essentially of the biocide mixture of the invention; in other words, besides the mixture, there may well be one or more other biocides present, but they are present in an amount at which there is no contribution by the respective biocide that is different from the components of the mixture to the total effect of the resulting mixture. If, therefore, the biocidal action of a biocide composition of the invention which, besides the components of the biocide mixture of the invention as an essential constituent, additionally contains one or more further biocides in minor or relatively minor concentration, is unchanged relative to the use of the biocide mixture of the invention, this is termed in the context of the present invention as “essentially consisting”. There may be one or more further constituents present that do not have a biocidal action, such as solvents, for instance.

In one further embodiment the biocide composition of the invention may be composed of the components of the biocide mixture of the invention as sole active biocidal compounds, i.e. an active compound content of 100% MIT/haloalkyl sulphone in the stated weight ratios. In such a case it is only possible for there to be one or more further constituents present without a biocidal action, such as solvents, for instance.

In one preferred embodiment the invention relates to a biocide composition comprising as active microbicidal components 2-methylisothiazolin-3-one and haloalkyl sulphone, more particularly diiodomethyl p-tolyl sulphone and MIT, with the exception of biocide compositions containing 5-chloro-2-methylisothiazolin-3-one. In this embodiment of the invention the biocide composition of the invention is free from 5-chloro-2-methylisothiazolin-3-one (CMIT). This means that CMIT is present in an amount of less than or equal to 5%, preferably less than or equal to 2%, more preferably less than 0.1%, in particular less than or equal to 0.01%, by weight, in the biocide composition. It is also possible for there to be no CMIT present (i.e. it is not detectable by the usual analytical methods). In this embodiment the invention also relates to preserved products which comprise the biocide composition of the invention and are free from 5-chloro-2-methylisothiazolin-3-one (CMIT). This means that CMIT is present in an amount of less than or equal to 5%, preferably less than or equal to 2%, more preferably less than or equal to 0.1%, in particular less than or equal to 0.01%, by weight, in the biocide composition. It is also possible for there to be no CMIT present (i.e. it is undetectable by the usual analytical methods).

In one advantageous embodiment the biocide composition is in the form of a liquid preparation, such as a solution, suspension or dispersion in a liquid medium, for example. The biocide composition of the invention can of course also be mixed directly in a product to be preserved. This is done by adding the individual active microbicidal components to the product that has to be preserved.

It is useful for the biocide composition of the invention to be present, for application, in combination with a polar or non-polar liquid medium.

Preferred polar liquid media are water, aliphatic alcohols having 1 to 4 carbon atoms, for example ethanol and isopropanol, a glycol, for example ethylene glycol, diethylene glycol, 1,2-propylene glycol, dipropylene glycol and tripropylene glycol, a glycol ether, such as butylglycol and butyldiglycol, a glycol ester, such as butylglycol acetate or 2,2,4-trimethylpentanediol monoisobutyrate, a polyethylene glycol, a propylene glycol, N,N-dimethylformamide or a mixture of two or more such media. The polar liquid medium is more particularly water and/or glycol.

Examples of possible non-polar liquid media include aromatics, preferably xylene and toluene, which may also be used alone or as mixtures of two or more such media.

The biocide composition of the invention may also be combined simultaneously with a polar or an non-polar liquid medium.

The biocide composition of the invention is generally adjusted in its pH to a pH of 4 to 7, preferably to a pH of 5 to 7.

Generally speaking it is possible to adapt the biocide composition to specific fields of application by adding further active compounds, in order, for example, to gain an increased action or an improved compatibility with the substances to be protected from the microorganisms. These further compounds are known to the skilled person in the field of biocides and can be selected by the skilled person as a function of the application of the biocide composition of the invention.

Specific examples of such further active biocidal compounds are specified below. The one or more further active biocidal compounds specified below are present in a ratio of (10:1) to (1:10), based on the total amount of MIT and the haloalkyl sulphone.

Benzyl alcohol; 2,4-dichlorobenzyl alcohol; 2-phenoxyethanol; phenylethyl alcohol; formaldehyde releasing substances, 5-brom-5-nitro-1,3-dioxane; bronopol; formaldehyde and formaldehyde releasing substances, such as 2-phenoxyethanol hemiformal, dimethyloldimethylhydantoin; N-methylolchloroacetamide; N-methylolurea; N,N′-dimethylolurea; benzyl formal; 4,4-dimethyl-1,3-oxazolidine; 1,3,5-hexahydrotriazine derivates; ethylene glycol hemiformal; glyoxal; glutaraldehyde; sorbic acid; benzoic acid; salicylic acid; p-hydroxybenzoic esters; chloroacetamide; phenols, such as p-chloro-m-cresol and o-phenylphenol; quaternary ammonium compounds, such as N-alkyl-N,N-dimethylbenzylammonium chloride and di-n-decyldimethylammonium chloride; cetylpyridinium chloride; diguanidine; polybiguanide; chlorhexidine; 1,2-dibromo-2,4-dicyanobutane; 3,5-dichloro-4-hydroxybenzaldehyde; tetra(hydroxymethyl)phosphonium salts; dichlorophen; 2,2-dibromo-3-nitrilopropionamide; 3-iodo-2-propynyl N-butylcarbamate; methyl N-benzimidazol-2-ylcarbamate; 2,2′-dithiodibenzoic acid di-N-methyl amide; 2-thiocyanomethylthiobenzothiazole; C-formals such as 2-hydroxymethyl-2-nitro-1,3-propanediol and 2-bromo-2-nitropropane-1,3-diol; methylenebisthiocyanate; reaction products of allantoin (with formaldehyde); N-alkyl-1,2-benzoisothiazolin-3-ones having 1 to 8 C atoms in the alkyl radical, 1,2-benzisothiazolin-3-one, N-methyl-1,2-benzisothiazolin-3-one; N-butyl-1,2-benzisothiazolin-3-one; 4,5-dichloro-2-n-octylisothiazolin-3-one (DCOIT); 2-n-octylisothiazolin-3-one (OIT), 4,5-trimethylene-2-methylisothiazolin-3-one; 3-iodo-2-propynyl N-butylcarbamate; methyl-N-benzimidazol-2-ylcarbamate; 2-thiocyanomethylthiobenzothiazole; methylenebisthiocyanate; chlorothalonil; propiconazole; tebuconazole; TCMTB; terbutryn, cyfluthrin, isoproturon, triclosan, diuron and Irgarol. Silver and silver compounds, such as elemental silver and silver salts, such as AgCl.

Formaldehyde releasing substances are compounds which, in an intended chemical reaction, give off formaldehyde in microbiologically active amounts. Compounds of this kind are listed and defined in the standard reference work in the microbicide field, Wilfried Paulus: Directory of Microbicides for the Protection of Materials and Processes. Springer Netherlands, Berlin 2006, ISBN 1-402-04861-0 in the chapter “Formaldehyde Releasing Compounds”. An important feature in the case of the formaldehyde depot substances is the presence of certain functional groups, such as a hydroxymethyl group, for example. Examples of formaldehyde releasing substances are N-formals, such as tetramethylolacetylenediurea (TMAD); N,N′-dimethylolurea; N-methylolurea; dimethyloldimethylhydantoin; N-methylolchloroacetamide; reaction products of allantoin; glycol formals, such as ethylene glycol formal; butyldiglycol formal; benzylformal.

According to the invention, preferred further active biocidal compounds are one or more biocides from the group consisting of 2-octyl-2H-isothiazolin-3-one, benzisothiazolin-3-one, N-methylbenzisothiazolin-3-one, N-butylbenzisothiazolin-3-one, 2,2′-dithiobis[N-methylbenzylamide], formaldehyde, tetramethylolacetylenediurea (TMAD), silver, iron pyrithione, zinc pyrithione, copper pyrithione and sodium pyrithione, 2-bromo-2-nitropropane-1,3-diol, 2,2-dibromo-3-nitrilopropionamide (DBNPA), 4,5-dichloro-2-n-octylisothiazolin-3-one (DCOIT) and 3-iodo-2-propynyl N-butylcarbamate (IPBC).

In a further embodiment the invention relates to biocide compositions which comprise:
(a) 2-methylisothiazolin-3-one, diiodomethyl p-tolyl sulphone and 2-octyl-2H-isothiazolin-3-one,
(b) 2-methylisothiazolin-3-one, diiodomethyl p-tolyl sulphone and benzisothiazolin-3-one,
(c) 2-methylisothiazolin-3-one, diiodomethyl p-tolyl sulphone and N-methylbenzisothiazolin-3-one,
(d) 2-methylisothiazolin-3-one, diiodomethyl p-tolyl sulphone and N-butylbenzisothiazolin-3-one,
(e) 2-methylisothiazolin-3-one, diiodomethyl p-tolyl sulphone and 2,2′-dithiobis[N-methylbenzylamide] (Densil P™),
(f) 2-methylisothiazolin-3-one, diiodomethyl p-tolyl sulphone and formaldehyde,
(g) 2-methylisothiazolin-3-one, diiodomethyl p-tolyl sulphone and one or more of the aforementioned formaldehyde depot substances,
(h) 2-methylisothiazolin-3-one, diiodomethyl p-tolyl sulphone and tetramethylolacetylenediurea (TMAD),
(i) 2-methylisothiazolin-3-one, diiodomethyl p-tolyl sulphone and silver,
(j) 2-methylisothiazolin-3-one, diiodomethyl p-tolyl sulphone and one or more pyrithiones selected from the group consisting of iron pyrithione, zinc pyrithione, copper pyrithione and sodium pyrithione,
(k) 2-methylisothiazolin-3-one, diiodomethyl p-tolyl sulphone and 2-bromo-2-nitropropane-1,3-diol,
(l) 2-methylisothiazolin-3-one, diiodomethyl p-tolyl sulphone and 2,2-dibromo-3-nitrilopropionamide (DBNPA),
(m) 2-methylisothiazolin-3-one, diiodomethyl p-tolyl sulphone and 4,5-dichloro-2-n-octylisothiazolin-3-one (DCOIT), and also
(n) 2-methylisothiazolin-3-one, diiodomethyl p-tolyl sulphone and 3-iodo-2-propynyl N-butylcarbamate.

The invention further relates to preserved products which comprise one of the aforementioned biocide compositions (a), (b), (c), (d), (e), (f), (g), (h), (i), (j), (k), (l), (m) or (n).

Generally speaking, in the aforementioned biocide compositions (a), (b), (c), (d), (e), (f), (g), (h), (i), (j), (k), (l), (m) or (n), the ratio of MIT and diiodomethyl p-tolyl sulphone to the further active compound is (1 to 10):(10 to 1), preferably (1 to 2):(2 to 1).

In one preferred embodiment the biocide composition (a) comprises the active biocidal compounds 2-methylisothiazolin-3-one, diiodomethyl p-tolyl sulphone and 2-octyl-2H-isothiazolin-3-one in a ratio of (1% to 10%):(0.2% to 5%):(2% to 20%) by weight. In one preferred embodiment the concentrations of the active biocidal compounds in the application, in other words in the container, are as follows: 25 to 250 ppm MIT, 50 to 2000 ppm OIT and 2 to 50 ppm DIMTS.

In one preferred embodiment the biocide composition (b) comprises the active biocidal compounds 2-methylisothiazolin-3-one, diiodomethyl p-tolyl sulphone and benzisothiazolin-3-one in a ratio of 2% to 20% (MIT):0.2% to 5% (DIMTS):2% to 20% (BIT) by weight. In one preferred embodiment the concentrations of the active biocidal compounds in the application, in other words in the container, are as follows: 25 to 250 ppm MIT, 25 to 500 ppm BIT and 2 to 50 ppm DIMTS.

In one preferred embodiment the biocide composition (c) comprises the active biocidal compounds 2-methylisothiazolin-3-one, diiodomethyl p-tolyl sulphone and N-methylbenzisothiazolin-3-one in a ratio of 2% to 20%:0.2% to 5%:2% to 20% by weight. In one preferred embodiment the concentrations of the active biocidal compounds in the application, in other words in the container, are as follows: 25 to 250 ppm MIT, 25 to 250 ppm M-methyl-BIT and 2 to 50 ppm DIMTS.

In one preferred embodiment the biocide composition (d) comprises the active biocidal compounds 2-methylisothiazolin-3-one, diiodomethyl p-tolyl sulphone and N-butylbenzisothiazolin-3-one in a ratio of 2% to 20%:0.2% to 5%:2% to 20% by weight.

In one preferred embodiment the concentrations of the active biocidal compounds in the application, in other words in the container, are as follows: 25 to 250 ppm MIT, 50 to 2000 ppm N-butyl-BIT and 2 to 50 ppm DIMTS.

In one preferred embodiment the biocide composition (e) comprises the active biocidal compounds 2-methylisothiazolin-3-one, diiodomethyl p-tolyl sulphone and 2,2′-dithiobis[N-methylbenzylamide] in a ratio of 2% to 20%:0.2% to 5%:2% to 20% by weight. In one preferred embodiment the concentrations of the active biocidal compounds in the application, in other words in the container, are as follows: 25 to 250 ppm MIT, 25 to 2000 ppm DTBMA and 2 to 50 ppm DIMTS.

In one preferred embodiment the biocide composition (f) comprises the active biocidal compounds 2-methylisothiazolin-3-one, diiodomethyl p-tolyl sulphone and formaldehyde in a ratio of 2% to 20%:0.2% to 5%:2% to 20% by weight. In one preferred embodiment the concentrations of the active biocidal compounds in the application, in other words in the container, are as follows: 25 to 250 ppm MIT, 25 to 500 ppm formaldehyde and 2 to 50 ppm DIMTS.

In one preferred embodiment the biocide composition (g) comprises the active biocidal compounds 2-methylisothiazolin-3-one, diiodomethyl p-tolyl sulphone and the formaldehyde depot substance in a ratio of 2% to 20%:0.2% to 5%:2% to 20% by weight. In one preferred embodiment the concentrations of the active biocidal compounds in the application, in other words in the container, are as follows: 25 to 250 ppm MIT, 25 to 2000 ppm formaldehyde depot substance and 2 to 50 ppm DIMTS.

In one preferred embodiment the biocide composition (h) comprises the active biocidal compounds 2-methylisothiazolin-3-one, diiodomethyl p-tolyl sulphone and the tetramethylolacetylenediurea (TMAD) in a ratio of 2% to 20%:0.2% to 5%:2% to 20% by weight. In one preferred embodiment the concentrations of the active biocidal compounds in the application, in other words in the container, are as follows: 25 to 250 ppm MIT, 50 to 1000 ppm tetramethylolacetylenediurea (TMAD) and 2 to 50 ppm DIMTS.

In one preferred embodiment the biocide composition (i) comprises the active biocidal compounds 2-methylisothiazolin-3-one, diiodomethyl p-tolyl sulphone and silver in a ratio of 2% to 20%:0.2% to 5%:2% to 20% by weight. In one preferred embodiment the concentrations of the active biocidal compounds in the application, in other words in the container, are as follows: 25 to 250 ppm MIT, 1 to 100 ppm silver and 2 to 50 ppm DIMTS.

In one preferred embodiment the biocide composition (j) comprises the active biocidal compounds 2-methylisothiazolin-3-one, diiodomethyl p-tolyl sulphone and the one or more pyrithiones selected from the group consisting of iron pyrithione, zinc pyrithione, copper pyrithione and sodium pyrithione in a ratio of 2% to 20%:0.2% to 5%:2% to 20% by weight. In one preferred embodiment the concentrations of the active biocidal compounds in the application, in other words in the container, are as follows: 25 to 250 ppm MIT, 25 to 2000 ppm pyrithione and 2 to 50 ppm DIMTS.

In one preferred embodiment the biocide composition (k) comprises the active biocidal compounds 2-methylisothiazolin-3-one, diiodomethyl p-tolyl sulphone and 2-bromo-2-nitropropane-1,3-diol in a ratio of 2% to 20%:0.2% to 5%:2% to 20% by weight. In one preferred embodiment the concentrations of the active biocidal compounds in the application, in other words in the container, are as follows: 25 to 250 ppm MIT, 25 to 500 ppm 2-bromo-2-nitropropan-1,3-diol and 2 to 50 ppm DIMTS.

In one preferred embodiment the biocide composition (l) comprises the active biocidal compounds 2-methylisothiazolin-3-one, diiodomethyl p-tolyl sulphone and 2,2-dibromo-3-nitrilopropionamide (DBNPA) in a ratio of 2% to 20%:0.2% to 5%:2% to 20% by weight. In one preferred embodiment the concentrations of the active biocidal compounds in the application, in other words in the container, are as follows: 25 to 250 ppm MIT, 25 to 1000 ppm 2,2-dibromo-3-nitrilopropionamide (DBNPA) and 2 to 50 ppm DIMTS.

In one preferred embodiment the biocide composition (m) comprises the active biocidal compounds 2-methylisothiazolin-3-one, diiodomethyl p-tolyl sulphone and 4,5-dichloro-2-n-octylisothiazolin-3-one (DCOIT) in a ratio of 2% to 20%:0.2% to 5%:2% to 20% by weight. In one preferred embodiment the concentrations of the active biocidal compounds in the application, in other words in the container, are as follows: 25 to 250 ppm MIT, 25 to 2000 ppm 4,5-dichloro-2-n-octylisothiazolin-3-one (DCOIT) and 2 to 50 ppm DIMTS.

In one preferred embodiment the biocide composition (n) comprises the active biocidal compounds 2-methylisothiazolin-3-one, diiodomethyl p-tolyl sulphone and 3-iodo-2-propynyl N-butylcarbamate in a ratio of 2% to 20%:0.2% to 5%:2% to 20% by weight. In one preferred embodiment the concentrations of the active biocidal compounds in the application, in other words in the container, are as follows: 25 to 250 ppm MIT, 25 to 2000 ppm 3-iodo-2-propynyl N-butylcarbamate and 2 to 50 ppm DIMTS.

In one embodiment of the invention the diiodomethyl p-tolyl sulphone present in the above-defined biocide compositions (a), (b), (c), (d), (e), (f), (g), (h), (i), (j), (k), (l), (m) or (n) and also in the corresponding preserved products may be replaced by one or more compounds of the general formula I. The respective proportions and concentrations of the compound or compounds of the general formula I correspond to the above disclosure in connection with diiodomethyl p-tolyl sulphone.

In one embodiment of the invention the above-defined biocide compositions or preserved products (a), (b), (c), (d), (e), (f), (g), (h), (i), (j), (k), (l), (m) or (n) are free from CMIT in accordance with the definition above.

In one embodiment of the invention the above-defined biocide compositions (a), (b), (c), (d), (e), (f), (g), (h), (i), (j), (k), (l), (m) or (n) comprise no active biocidal substances other than the stated active biocidal substances.

The biocide composition of the invention, and also the biocide compositions (a), (b), (c), (d), (e), (f), (g), (h), (i), (j), (k), (l), (m) or (n), may in addition also comprise other customary constituents which are known to the skilled person in the field of biocides as adjuvants. These are, for example, thickeners, defoamers, compounds for setting and buffering the pH, fragrances, dispersing assistants, and colouring or discoloration-preventing substances, complexing agents and stabilizers.

The solvent used is one selected from the group consisting of water, aliphatic alcohols having 1 to 4 carbon atoms, such as ethanol and isopropanol, a glycol, such as ethylene glycol, diethylene glycol, 1,2-propylene glycol, dipropylene glycol and tripropylene glycol, a glycol ether, such as butylglycol and butyldiglycol a glycol ester, such as butylglycol acetate or 2,2,4-trimethylpentanediol monoisobutyrate, a polyethylene glycol, a propylene glycol, N,N-dimethylformamide or a mixture of two or more thereof. The polar liquid medium is more particularly water and/or glycol.

The isothiazolin-3-ones used as an active microbiocidal component are known substances and are available as such commercially or can be prepared by known methods.

The biocide composition of the invention can be used for preserving products in a great variety of fields. It is suitable, for example, for use as a composition for preserving lignosulphonates and starch preparations, and also for use in coating materials, such as, for example, paints, varnishes, glazes and stucco, in emulsions, latices, polymer dispersions, caulk suspensions, mineral slurries, ceramic masses, adhesives, fragrances, casein products, starch products, bitumen emulsions, surfactant solutions, motor fuels, cleaning products, pigment pastes and pigment dispersions, liquid inks, lithographic fluids, thickeners, cosmetic products, toiletries, water circuits, liquids in paper processing, liquids in wood processing, liquids in petroleum extraction, liquids in leather production, liquids in textile production, drilling and cutting oils, hydraulic fluids and cooling lubricants, against infestation by—for example—bacteria, filamentous fungi, yeasts and algae.

Preferably the biocide composition of the invention is used to counter infestation by microorganisms in products, such as lignosulphonates and starch preparations and also in coating materials, such as, for example, paints, varnishes, glazes and stucco, in emulsions, latices, polymer dispersions, adhesives, cleaning products, mineral slurries, ceramic masses, pigment pastes and pigment dispersions, and also sealants. Particularly preferred fields of use are the preservation of lignosulphonates, starch preparations, and also the preservation of water circuits, liquids in paper processing, liquids in wood processing, liquids in petroleum extraction, liquids in leather production, liquids in textile production, drilling and cutting oils, hydraulic fluids and cooling lubricants.

With particular preference the biocide composition of the invention is used for preserving coating materials such as, for example, paints, varnishes, glazes and stucco and also adhesives for the interior sector. The term “interior sector” refers for the purposes of the invention more particularly to application in rooms.

In practical application, the biocide composition may be incorporated either as a ready-made mixture, or by separate addition of the active microbicidal components of the composition, into the substance or product that is to be preserved.

In the substance or product to be preserved with the biocide composition of the invention, the MIT is present preferably in an amount of 5 to 500 ppm, more preferably in an amount of 5 to 200 ppm, more preferably in an amount of 10 to 150 ppm, with particular preference in an amount of 20 to 100 ppm. The amount of the diiodomethyl p-tolyl sulphone in the substance or product to be preserved is preferably 1 to 500 ppm, more preferably 1 to 100 ppm, with particular preference 1 to 50 ppm, and with especial preference 5 to 25 ppm. To prevent the occurrence of ghost odour, concentrations of haloalkyl sulphone of 0.1 ppm to 25 ppm are preferred.

In one embodiment of the invention the biocide composition of the invention takes the form of a concentrate which is added to the substances or products to be preserved. The concentrate advantageously contains the MIT in an amount of 0.5% to 50%, preferably in an amount of 1% to 20%, more preferably in an amount of 2.5% to 10%, by weight, based on the total mass of the concentrate. The amount of diiodomethyl p-tolyl sulphone in the concentrate is 0.5 to 50%, preferably 1% to 20%, more preferably 1% to 5%, by weight, based on the total mass of the concentrate.

The biocide composition of the invention can be prepared by mixing the constituents with stirring in any order at a temperature of 25+/−20° C. In one preferred embodiment of the invention the biocide composition is prepared by dissolving the MIT in water with stirring and dispersing the diiodomethyl p-tolyl sulphone into the solution. For formulating and/or stabilizing it is possible in this context to use dispersing assistants that are known to the skilled person, such as water-soluble polymers with a dispersing action (generally polyanions) such as polyacrylic acids having a molecular weight of 1000 to 100 000 or copolymers of acrylic acid with maleic anhydride having a molecular weight of 1000 to 100 000, aromatic sulphonic acid condensates such as phenolsulphonic acid, naphthalenesulphonic acid with formaldehyde, and also silicone resins. It is possible, furthermore, for stabilizeres such as xanthans, modified celluloses, such as methylcellulose, polyurethane thickeners and silica to be present. Likewise present may be wetting agents known to the skilled person, such as dioctyl sulphosuccinate, C₁₀ to C₁₃ fatty alcohol ethoxylates, EO/PO block polymers, sulphonates, and also defoamers such as silicone defoamers and fillers, such as talc, kaolins, titanium dioxide, silicates, fumed silica and/or zeolites.

In one preferred embodiment of the invention the MIT and the further biocidal active compounds, where appropriate, of the biocide composition of the invention are enclosed in the interior of microcapsules. Microcapsules with biocides enclosed in their interior are described in the applicant's WO 2004/000953. Preferred materials for the microcapsule wall are melamine-formaldehyde resins.

An unexpected advantage of the present invention is that synergistic biocidal activity is achieved if the MIT is used together with the diiodomethyl p-tolyl sulphone as a biocide.

The examples which follow serve for further illustration of the present invention.

### EXAMPLE 1

### Investigation of the Synergistic Effect

The synergism of a combination of MIT with diiodomethyl p-tolyl sulphone was tested. Test organisms used were the Gram-negative bacterium Pseudomonas aeruginosa (ATCC 9027) and the mould Aspergillus niger (ATCC16404). For the purpose of the test, mixtures containing different concentrations of MIT and diiodomethyl p-tolyl sulphone were prepared and tested for their action on Pseudomonas aeruginosa and Aspergillus niger respectively. The active compound mixtures in the corresponding concentrations were introduced into selective nutrient media (nutrient agar for Pseudomonas aeruginosa and Sabouraud glucose agar for Aspergillus niger) and the test organisms were likewise incorporated into the agar. The cell density in the agar was in each case 10⁶ microbes per ml in the case of Pseudomonas aeruginosa and 10⁵ spores per ml in for Aspergillus niger.

The incubation time is 48 hours (bacteria) or 72 hours (moulds) at 30° C. and 25° C. respectively. This was followed by visual testing for growth of Pseudomonas aeruginosa and Aspergillus niger. In the case of Pseudomonas aeruginosa, growth was apparent by hazing or greenish coloration of the nutrient medium, or by formation of colonies on the surface of the agar. In the case of Aspergillus niger, the growth was apparent through the formation of colonies or mycelia on the surface of the agar. In this way the minimum inhibitory concentrations (MICs) of the two active compounds were determined, individually and in combination. The MIC is the concentration at which there is no longer any hazing, colouring of the agar or colony formation on the surface of the agar (Pseudomonas aeruginosa) and no formation of colonies or mycelia on the surface of the agar (Aspergillus niger).

The synergism that occurred was presented numerically by calculation of the synergy index (SI). This calculation was made using the common method of F. C. Kull et al., Applied Microbiology, vol. 9 (1961), p. 538. SI is calculated there in accordance with the following formula:

Synergy index SI=Qₐ/Q_{A}+Q_{b}/Q_{B}

In the application of this formula to the MIT+DIMTS biocide system tested here, the variables in the formula have the following definition:

Qₐ=concentration of MIT in the mixture of diiodomethyl p-tolyl sulphone+MIT
Q_{A}=concentration of MIT as sole biocide
Q_{b}=concentration of diiodomethyl p-tolyl sulphone in the biocide mixture
Q_{B}=concentration of diiodomethyl p-tolyl sulphone as sole biocide

If the synergy index has a value of more than 1, this means that there is an antagonism.

If the synergy index adopts a value of 1, this means that the action of the two biocides is additive. If the synergy index takes on a value of below 1, this means that there is synergism of the two biocides.

TABLE 1
Calculation of the synergy index of diiodomethyl p-tolyl sulphone (called DIMTS in the
table) + MIT in respect of Pseudomonas aeruginosa for an incubation time of 48 hours at
30° C.

| MHK Qa | MHK Qb | Total | | | | | Synergy index |
|---|---|---|---|---|---|---|---|
| (MIT) | (DIMTS) | [ppm] | % by wt. | % by wt. | | | Index Qa/QA + |
| [ppm] | [ppm] | ppm | MIT | DIMTS | Qa/QA | Qb/QB | Qb/QB |
| 40 | 0 | 40 | 100.0 | 0.0 | 1.00 | 0.00 | 1.00 |
| 30 | 100 | 130 | 23.1 | 76.9 | 0.75 | 0.08 | 0.83 |
| 25 | 200 | 225 | 11.1 | 88.9 | 0.63 | 0.16 | 0.79 |
| 20 | 400 | 420 | 4.8 | 95.2 | 0.50 | 0.32 | 0.82 |
| 15 | 500 | 515 | 2.9 | 97.1 | 0.38 | 0.40 | 0.78 |
| 10 | 700 | 710 | 1.4 | 98.6 | 0.25 | 0.56 | 0.81 |
| 5 | 800 | 805 | 0.6 | 99.4 | 0.13 | 0.64 | 0.77 |
| 0 | 1250 | 1250 | 0.0 | 100.0 | 0.00 | 1.00 | 1.00 |

Qa: concentration of MIT in the mixture which shows an endpoint
QA: concentration of MIT as sole agent that shows an endpoint.
Qb: concentration of DIMTS in the mixture that shows an endpoint
QB: concentration of DIMTS as sole agent that shows an endpoint

From Table 1 it is evident that the optimum synergy, i.e. the lowest synergy index (0.77) of a biocide composition composed of MIT and diiodomethyl p-tolyl sulphone, is present at a ratio of 0.6% by weight diiodomethyl p-tolyl sulphone to 99.4% by weight MIT.

TABLE 2
Calculation of the synergy index of diiodomethyl p-tolyl sulphone (called DIMTS in the
table) + MIT in respect of Aspergillus niger for an incubation time of 72 hours at 25° C.

| MHK Qa | MHK Qb | | | | | | Synergy index |
|---|---|---|---|---|---|---|---|
| (MIT) | (DIMTS) | Total | % by wt. | % by wt. | | | Index Qa/QA + |
| [ppm] | [ppm] | [ppm] | MIT | DIMTS | Qa/QA | Qb/QB | Qb/QB |
| 800 | 0 | 800 | 100.0 | 0.0 | 1.00 | 0.00 | 1.00 |
| 600 | 1 | 601 | 99.8 | 0.2 | 0.75 | 0.10 | 0.85 |
| 500 | 2 | 502 | 99.6 | 0.4 | 0.63 | 0.20 | 0.83 |
| 300 | 3 | 303 | 99.0 | 1.0 | 0.38 | 0.30 | 0.68 |
| 200 | 4 | 204 | 98.0 | 2.0 | 0.25 | 0.40 | 0.65 |
| 100 | 5 | 105 | 95.2 | 4.8 | 0.13 | 0.50 | 0.63 |
| 0 | 10 | 10 | 0.0 | 100.0 | 0.00 | 1.00 | 1.00 |

Qa: concentration of MIT in the mixture which shows an endpoint
QA: concentration of MIT as sole agent that shows an endpoint.
Qb: concentration of DIMTS in the mixture that shows an endpoint
QB: concentration of DIMTS as sole agent that shows an endpoint

From Table 2 it is evident that the optimum synergy, i.e. the lowest synergy index (0.63) of a biocide composition composed of MIT and diiodomethyl p-tolyl sulphone, is present at a ratio of 4.8% by weight diiodomethyl p-tolyl sulphone to 95.2% by weight MIT.

### EXAMPLE 2

### Investigation of the Odour-Inhibiting Effect

The experiments below were carried out using a satin sheen paint with the composition indicated in Table 1. The preservative used was 2-methyl-4-isothiazolin-3-one (Kordek® MLX, 9.7% MIT, Rohm & Haas).

TABLE 1
Composition of the paint

| | | | Amount | |
|---|---|---|---|---|
| Raw material | Name | Manufacturer/supplier | (g) | % |
| Water | — | — | 872 | 7.50 |
| Cellulose ether | Hydroxyethylcellulose | Hercules | 12 | 0.25 |
| Dispersant | Tamol 1124 | Rohm & Haas | 12 | 0.30 |
| Defoamer | LB-8041/4 | HI-MAR Specialties | 10 | 0.25 |
| Ammonium | | Fisher Scientific | 2 | 0.10 |
| hydroxide | | | | |
| Calcium | HuberCarb Q325 | Huber | 312 | 7.80 |
| carbonate | | | | |
| Titanium | Tiona 596 | Millenium | 624 | 15.60 |
| dioxide | | | | |
| Propylene | | Fisher Scientific | 72 | 1.80 |
| glycol | | | | |
| Coalescer | Texanol | Ashland Chemical | 60 | 1.50 |
| Acrylate | Rhoplex AC 264 | Rohm & Haas | 2024 | 50.60 |
| dispersion | | | | |
| | | Total | 4000 | 100.00 |

The paint is admixed with the quantity of MIT indicated in Table 2, and homogenized. Subsequently the inhibitors under investigation are weighed in. A sample with MIT only, as a sole additive without inhibitors, serves as a positive control. A blank sample without MIT is used as a reference sample.

The liquid paint samples thus prepared are divided into three series. Sample series A is applied to glass slides immediately after preparation and dried at room temperature and 60%+/−10% relative humidity for 24 hours to produce a paint film. Sample series B is stored in the wet state in a closed vessel at 40° C. for 14 days. Sample series C is stored in the wet state in a closed vessel at 40° C. for 28 days. When storage is at an end, a paint film is produced from sample series B and sample series C in the same way as for sample series A.

The dried paint films are peeled from the glass slide and placed in a dish or watch glass. Subsequently the dried coating materials are treated with ozone in a desiccator with a water jet pump attached (Brand, suction performance approximately 500 l/h). For this purpose the air entering the desiccator is passed via an ozone generator (ozone generator COM-SD-30, capacity 30 mg ozone/h, Anseros). The ozonization takes place at room temperature with a relative humidity of 60%+/−10% for a period of 1 minute. The sample vessels are then removed and the sample material is investigated by olfactory means for typical odour.

For the olfactory evaluation, a panel of five testers was selected, which evaluated the intensity of the odour of each individual sample. The testers were familiar with the typical “ghost odour” and on the basis of their knowledge were capable of assigning it unambiguously.

The intensity of the odour of the individual samples is investigated by all of the members of the panel, without them knowing which samples were “test samples” and which samples were “control samples”, and without knowing what score the other members of the panel had awarded by smelling each sample and assigning it a score. The evaluation scale for the strength/intensity of the odour, with 0 being no odour at all and 3 being strong odour, is shown below:

| Score | Degree of odour |
|---|---|
| 0 | no odour |
| 1 | slight indefinite odour |
| 2 | slight but unambiguous odour |
| 3 | strong |

From the scores awarded by the testers for each sample, an average is formed. In order to ensure that the selection of the group is satisfactory for carrying out the test, the rounded average of the samples without MIT ought not to exceed a value of 0, and the rounded average of sample series B and C, with MIT and without inhibitor, ought not to be below a figure of 2. If these criteria were not met, a new group was put together. From the evaluations by the five testers, the average was formed and rounded to a whole number. The results are set out in Table 2.

The concentration dependency and time dependency of the ghost odour is clearly apparent from the results shown in Table 2.

TABLE 2
Results of odour test after ozonization of the dried paint film

| | | | Odour | Odour | Odour |
|---|---|---|---|---|---|
| | | | of | of | of |
| | | Amount | sample | sample | sample |
| | | of | series | series | series |
| Batch | Inhibitor | inhibitor | (A) | (B) | (C) |
| without MIT | none | — | 0 | 0 | 0 |
| +125 ppm MIT | none | — | 0 | 0 | 1 |
| +250 ppm MIT | none | — | 0 | 1 | 2 |
| +500 ppm MIT | none | — | 1 | 3 | 3 |
| +1000 ppm MIT | none | — | 1 | 3 | 3 |
| +500 ppm MIT | diiodomethyl | 10 ppm | 0 | 0 | 0 |
| | p-tolyl | | | | |
| | sulphone | | | | |

1. Biocide composition comprising as active microbicidal components 2-methylisothiazolin-3-one and one or more haloalkyl sulphones according to the general structural formula I, 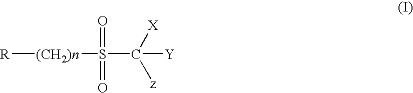
where
R is selected from the group H; alkyl; cycloalkyl, aralkyl, aryl, alkoxyaryl and heteroaryl, the groups alkyl; cycloalkyl, aralkyl, aryl, alkoxyaryl and heteroaryl being optionally substituted by one or more substituents,
X, Y and Z independently of one another are selected from the group consisting of hydrogen, fluorine, chlorine, bromine and iodine, at least one of X, Y and Z being a halogen atom, and
n is an integer from 0 to 4.

2. Biocide composition according to claim 1, the compound or compounds according to the general structural formula I being selected from the group consisting of 4-tolyl diiodomethyl sulphone, phenyl diiodomethyl sulphone, 4-tolyl dibromomethyl sulphone, 4-tolyl tribromomethyl sulphone, 4-(methylamido)phenyl diiodomethyl sulphone, n-heptyl diiodomethyl sulphone, 4-aminophenyl diiodomethyl sulphone, 4-chlorophenyl diiodomethyl sulphone, 4-tert-butylphenyl diiodomethyl sulphone, 3-tolyl diiodomethyl sulphone, 2-tolyl-diiodomethyl sulphone, 4-bromophenyl diiodomethyl sulphone, 2-methyl-4-chlorophenyl diiodomethyl sulphone, α-naphthyl diiodomethyl sulphone, 2-methyl 4-bromophenyl diiodomethyl sulphone, 3-methyl-4-bromophenyl diiodomethyl sulphone, n-butyl diiodomethyl sulphone, benzyl diiodomethyl sulphone, 2,4-dimethylphenyl diiodomethyl sulphone, 3,4-dichlorophenyl diiodomethyl sulphone, 4-chlorophenyl dibromomethyl sulphone, 4-methoxyphenyl dibromomethyl sulphone, ethyl diiodomethyl sulphone, tert-butyl diiodomethyl sulphone, 4-chlorophenyl tribromomethyl sulphone, 4-methoxyphenyl tribromomethyl sulphone, benzyl iodomethyl sulphone, ethyl diiodomethyl sulphone, 2-methyl-4-tert-butylphenyl diiodomethyl sulphone, 2-nitro-4-methylphenyl dibromomethyl sulphone, 2-nitro-4-methylphenyl tribromomethyl sulphone, 3-tolyl tribromomethyl sulphone, 4-tert-butylphenyl bromomethyl sulphone, 2-nitro-4-methylphenyl iodomethyl sulphone, 4-chlorobenzyl diiodomethyl sulphone, 2-nitro-4-chlorophenyl iodomethyl sulphone, 2-nitro-4-chlorophenyl tribromomethyl sulphone, 4-nitrophenyl diiodomethyl sulphone, 2-methyl 4-tert-butylphenyl tribromomethyl sulphone, 2-nitro-4-chlorophenyl diiodomethyl sulphone, 2-isopropylphenyl bromomethyl sulphone, 2-isopropylphenyl diiodomethyl sulphone, 4-nitrophenyl tribromomethyl sulphone, 4-(2,2-dimethylpropyl)phenyl diiodomethyl sulphone, 4-chlorobenzyl diiodomethyl sulphone, cyclohexyl diiodomethyl sulphone, n-pentyl diiodomethyl sulphone, n-hexyl diiodomethyl sulphone, n-propyl diiodomethyl sulphone, n-octyl diiodomethyl sulphone, 4-methylbenzyl diiodomethyl sulphone, 4-fluorobenzyl diiodomethyl sulphone, 4-bromobenzyl diiodomethyl sulphone, 4-methoxybenzyl diiodomethyl sulphone, 3-chlorobenzyl diiodomethyl sulphone, 3,5-dimethyl diiodomethyl sulphone, 1-phenyl-2-(diiodomethylsulphonyl)ethane, 3-bromobenzyl diiodomethyl sulphone, 2-naphthylmethyl diiodomethyl sulphone, 1-phenyl-3-(diiodomethylsulphonyl)propane, isobutyl diiodomethyl sulphone, 3,4-dimethylbenzyl diiodomethyl sulphone, 3,3-dimethylpropyl diiodomethyl sulphone, 2,2,4,4-tetramethylbutyl diiodomethyl sulphone, 4-fluorobenzyl dibromomethyl sulphone, 3-chlorobenzyl dibromomethyl sulphone, 4-bromobenzyl dibromomethyl sulphone, 3,4-dichlorobenzyl dibromomethyl sulphone, 2,4-dichlorobenzyl dibromomethyl sulphone, 3-bromobenzyl dibromomethyl sulphone, 2-bromobenzyl dibromomethyl sulphone, 2-chlorobenzyl dibromomethyl sulphone, 4-methylbenzyl dibromomethyl sulphone, 2-methylbenzyl dibromomethyl sulphone, 3-methylbenzyl dibromomethyl sulphone, 4-nitrobenzyl dibromomethyl sulphone, 4-methoxybenzyl dibromomethyl sulphone, 2,5-dimethylbenzyl dibromomethyl sulphone, 3,4-dimethylbenzyl dibromomethyl sulphone, 1-phenyl-2-dibromomethylsulphonyl ethane, 1-phenyl-3-(dibromomethylsulphonyl)propane, cyclohexyl dibromomethyl sulphone, n-heptyl dibromomethyl sulphone, n-decyl dibromomethyl sulphone, n-hexadecyl dibromomethyl sulphone, 3-methylpropyl diiodomethyl sulphone and n-decyl diiodomethyl sulphone.

3. Biocide composition according to claim 1, the compound according to the general formula I being diiodomethyl p-tolyl sulphone.

4. Biocid composition according to claim 1, with the exception of biocide compositions containing 5-chloro-2-methylisothiazolin-3-one.

5. Biocide composition according to claim 1, characterized in that 2-methylisothiazolin-3-one and the one or more compounds according to general formula I are present in a weight ratio of (100 to 1):(1 to 50).

6. Biocide composition according to claim 1, characterized in that it comprises the active microbicidal components in a total concentration of 0.5% to 50% by weight, based on the total biocide composition.

7. Biocide composition according to claim 1, characterized in that it comprises a polar medium.

8. Biocide composition according to claim 1, characterized in that it comprises a non-polar medium.

9. Biocide composition according to claim to 7, characterized in that it comprises as polar liquid medium water, an aliphatic alcohol having 1 to 4 carbon atoms, a glycol, a glycol ether, a glycol ester, a polyethylene glycol, a propylene glycol, N,N-dimethylformamide, 2,2,4-trimethylpentanediol monoisobutyrate or a mixture of such.

10. Biocide composition according to claim 8, characterized in that it is present in the form of a liquid preparation.

11. Biocide composition according to claim 1, characterized in that it comprises one or more further biocides selected from the group consisting of 2-octyl-2H-isothiazolin-3-one, benzisothiazolin-3-one, N-methylbenzisothiazolin-3-one, N-butylbenzisothiazolin-3-one, 2,2′-dithiobis[N-methylbenzylamide], formaldehyde, tetramethylolacetylenediurea (TMAD), silver, iron pyrithione, zinc pyrithione, copper pyrithione and sodium pyrithione, 2-bromo-2-nitropropane-1,3-diol, 2,2-dibromo-3-nitrilopropionamide, (DBNPA), 4,5-dichloro-2-n-octylisothiazolin-3-one (DCOIT) and 3-iodo-2-propynyl N-butylcarbamate (IPBC) as active microbicidal component(s).

12. Method of use of the biocide composition according to claim 1 for the in-can preservation of coating materials such as paints, varnishes and stucco, of polymer dispersions, emulsions, latices and adhesives.

13. Preserved product comprising a biocide composition as described in claim 1.

14. Preserved product according to claim 13, selected from lignosulphonates and starch preparation in coating materials, paints, varnishes, glazes and renders, emulsions, latices, polymer dispersions, chalk suspensions, mineral slurries, ceramic masses, adhesives, fragrances, casein products, starch products, bitumen emulsions, surfactant solutions, motor fuels, cleaning products, pigment pastes and pigment dispersions, liquid inks, lithographic fluids, thickeners, cosmetic products, toiletries, water circuits, liquids in wood processing, liquids in petroleum extraction, liquids in paper processing, liquids in leather production, liquids in textile production, drilling and cutting oils, hydraulic fluids and cooling lubricants.

15. Method of use of one or more compounds according to the general formula of claim 1 as an additive for reducing “ghost odour” in compositions containing 2-methylisothiazolin-3-one.
